(19) United States
(12) Patent Application Publication
(10) Pub. No.: US 2008/0264607 A1
(43) Pub. Date: Oct. 30, 2008

(54) Water treatment

(76) Inventor: Claude L. Hebert, Boucherville (CA)

Correspondence Address: Eric Fincham, 316 Knowlton Road, Lac Brome, QC, J0E 1V0, CA

(21) Appl. No.: 12/148,450

(22) Filed: Apr. 18, 2008

(30) Foreign Application Priority Data
Apr. 18, 2007 (CA) 2,585,394

(51) Int. Cl. F28G 13/00; C02F 1/48

(52) U.S. Cl. 165/95; 210/695

(57) ABSTRACT

A method and device for removing scaling from the interior of a conduit used in a heat transfer device, the method comprising the steps of diverting a portion of the fluid from the conduit, passing the diverted portion through a filter, passing the filtered portion through a magnetic field, and reintroducing the fluid into the conduit. The method of the present invention can also be used with chillers to control bacterial growth therein.

### FIELD OF THE INVENTION

The present invention relates to a method for treating water and a system for treating water, particularly industrial water used in heat exchangers and chillers.

### BACKGROUND OF THE INVENTION

Numerous heating and cooling systems using water circulation in closed loops age prematurely. In many buildings and industrial plants, these CVC systems show signs of deterioration and weakening performance signs after only a few years. This loss of efficiency is not always quickly detected right away, because it is not very apparent if one does not pay close and regular attention to it. Eventually, this will translate in pumping difficulties and poor performance of the thermo-exchange equipments. This loss in performance is usually caused by corrosion and scaling of the piping system.

If no preventive action against corrosion and limestone deposits is taken, they have to be dissolved in an acid solution, which is costly and damaging to the environment. This must be repeated regularly since it does not prevent any ulterior limestone deposits in the circuits.

Furthermore, each acid treatment will cause corrosion of the metal installations, therefore reducing their durability.

The deterioration of these systems always seem surprising since, in theory, they are insulated, without possible evaporation, without any need to be purged or changing the water. At first, this characteristic seems advantageous because the relative waterproofness limits the addition of water contaminants. Unfortunately, the limitation in water changing does not immediately eliminate all contaminants and a prolonged stay of the fluid inside the circuit is not always an advantage. The reality is quite different.

The water circulating through the closed loops usually contains fine particles in suspension which can cause many problems like scaling and abrasion. This invariably results in abnormally quick wear of the components et loss of efficiency. These particles come from various sources, including manufacturing debris cause by construction or contaminants introduced during repair or maintenance work on the network. However, the most part of the particles in suspension contained the water of these networks are caused by corrosion. The presence of oxygen, the different metals and microbiological activity are the main causes of this corrosion. The presence of oxygen is not surprising and it can be brought into the water in different ways: supply of new water, the pump fittings, the fans, pressure variations, etc. Oxygen, even in low concentration, always causes corrosion. Without suitable preventive measures, this dissolved gas will be responsible for stringing degradation, the most frequent type of corrosion of water circulation systems.

Contact between different metals is not unusual in these loops and this can cause corrosion of galvanized pipes. Finally, the presence of bacteria, mainly silt causing bacteria and sulfate reduction bacteria (SRB), are a significant element in terms of the problems of fouling and corrosion.

The presence of residue on the metallic surfaces is always a source of problems and it is always best to take preventive measures against this. However, when residue has already started accumulating inside the piping network, any preventive effort will have little effect and deterioration will continue to progress. In such a situation, the catalytic treatment we proposed herein to remove scale becomes essential.

Another factor which should be considered is the efficiency of the prevention treatment program. It is in fact impossible to obtain a reasonable protection if the surfaces to be protected are not in the right condition for it. On one hand, the corrosion inhibitors cannot be efficient on blocked surfaces and on the other hand, residue accumulation is a good place for microbic growth. Letting a blocked piping system stay that way will only make things worse and will lead to corrosion and gradual deterioration of the surfaces.

### SUMMARY OF THE INVENTION

It is an object of the present invention to provide a system suitable for chillers or other heat exchangers and which system can prevent scaling and where scaling has occurred, can remove the scale.

It is a further object of the present invention to provide a method for the removal of scale from pipes or other conduits such as are used in heat exchangers.

According to one aspect of the present invention, there is provided a method for removing scale from the interior of a conduit in a heat exchanger environment wherein a fluid passes through the conduit, the method comprising the steps of diverting a portion of the fluid from the conduit, passing the diverted portion through a filter, passing the portion from the filter through a magnetic field in a direction to cut lines of flux such that the direction of water flow and the direction of the flux lines are set at an angle, and reintroducing the fluid into the conduit at a point downstream of a point where the fluid is diverted.

According to a further aspect of the present invention, there is provided a method for removing bacteria from a heat transfer system having a chiller and wherein a fluid is circulated through a conduit, the method comprising the steps of diverting a portion of the fluid from the conduit, passing the diverted portion through a filter, passing the portion from the filter through a magnetic field in a direction to cut lines of flux such that the direction of water flow and the direction of the flux lines are set at an angle, and reintroducing the fluid into the conduit at a point downstream of a point where the fluid is diverted.

In the first aspect of the present invention, it is believed that the changing morphology of the solids as they are subjected to the magnetic field is changed and they will then act as an abrasive while circulating through the conduits to remove deposits from therein. The removed deposits are then picked up by the filter. Naturally, one can control the removal to a certain extent by the particle sizes permitted to pass through the filter. Since the removed deposits will accumulate in the filter, it is advisable to monitor the pressure drop across the filter to signal when a change of the filter is required.

The problem of corrosion can effect many metals although pipes of iron of steel are most common. With iron pipes, the oxide formed by oxidation does not firmly adhere to the surface of the metal and flakes off relatively easily causing pitting. Extensive pitting eventually causes structural weakness and disintegration of the metal. With aluminum, a different problem occurs in that a very tough oxide coating is formed which strongly bonds to the surface of the metal.

The formation of rust in metal pipes could occur at some distance away from the actual pitting or erosion of the iron. This is possibly because electrons produced by the initial oxidation of iron can be conducted through the metal and the ions can defuse through the water layer to another point on the metal surface where oxygen is available. This process essentially results in an electrical chemical cell in which iron serves as an anode, oxygen gas as a cathode and the aqueous solution of ions serving as a salt bridge therebetween.

A still further problem with industrial water is in microbiological control. Microbiological activity in a closed loop system can degrade performance and needs to be prevented. Generally, in a closed loop system, biocides are not suitable since each of them has side effects limiting their overall utility. Thus, oxidizing biocides such as chlorine or bromine are rarely effective at eliminating all microbes due to the fact that the biocides are catalystically decomposed by iron and copper corrosion products and even the metal surfaces. This means that the system can be readily reinnoculated from zones that did not “see” the biocide. Also, oxidizing biocides produced by products which build up over repeated treatments and will increase the corrosiveness of the water.

### BRIEF DESCRIPTION OF THE DRAWINGS

Having thus generally described the invention, reference will be made to the accompanying drawings illustrating an embodiment thereof, in which:

FIG. 1 is a schematic view of a system according to one embodiment of the present invention; and

FIGS. 2 to 5 are schematic views of other types of systems according to the present invention.

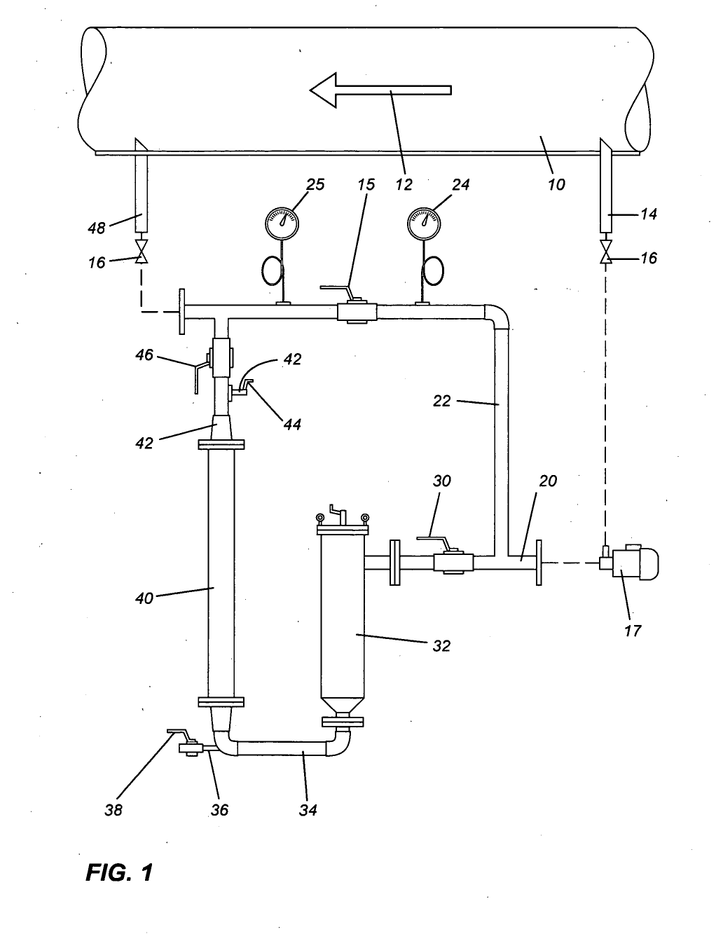

### DETAILED DESCRIPTION OF THE INVENTION

Referring to the drawing in greater detail and by reference characters thereto, there is illustrated a treatment system according to an embodiment of the present invention. The system is designed to be used with a closed circuit heat exchanger which includes a pipe 10 having fluid circulating in the direction indicated by arrow 12.

The system will include a conduit 14 which is tapped into pipe 10 such that a certain portion of the water within the heat transfer circulation will be diverted thereto. Preferably, the amount is between 5 and 15 percent and even more preferably between 8 and 10 percent of the total flow.

Conduit 14 includes a valve 16 thereon and is provided a pump 17 on the line, depending upon the desired pressures.

A system inlet 20 has a bypass conduit 22 located thereat. On bypass conduit 22 there are provided pressure gages 24 and 25 with a valve 26 therebetween.

Treatment line 28 has a valve 30 thereon. A filter 32 having the desired filtering media therein filters the water to be treated. From filter 32, there is provided a conduit 34. On conduit 34, there is provided a discharge line 36 and associated valve 38. A magnetic treatment device 40 is of the type shown in U.S. Pat. No. 5,149,438, the teachings of which are hereby incorporated by reference. After magnetic treatment device 40, there is also provided a discharge line 42 with associated valve 44. On conduit 45, there is provided a valve 46 and this is connected to a return line 48 feeding back into main pipe 10.

In operation, the filter size can be of great importance. Thus, when the system is installed in pipes suffering from scaling, the size of particles permitted to pass through the filter can be slightly larger than normal. It has been found that allowing these particles to pass through and then treating these particles with magnetic treatment device 40, that the particles will tend to “scrub” the scale from the pipes. As the scale is removed, the filter can be changed to further limit the size of particles passing therethrough.

During the process iron oxide is picked up within the magnetic treatment device and retained therein. These iron oxide particles can be removed through discharge line 42 when required.

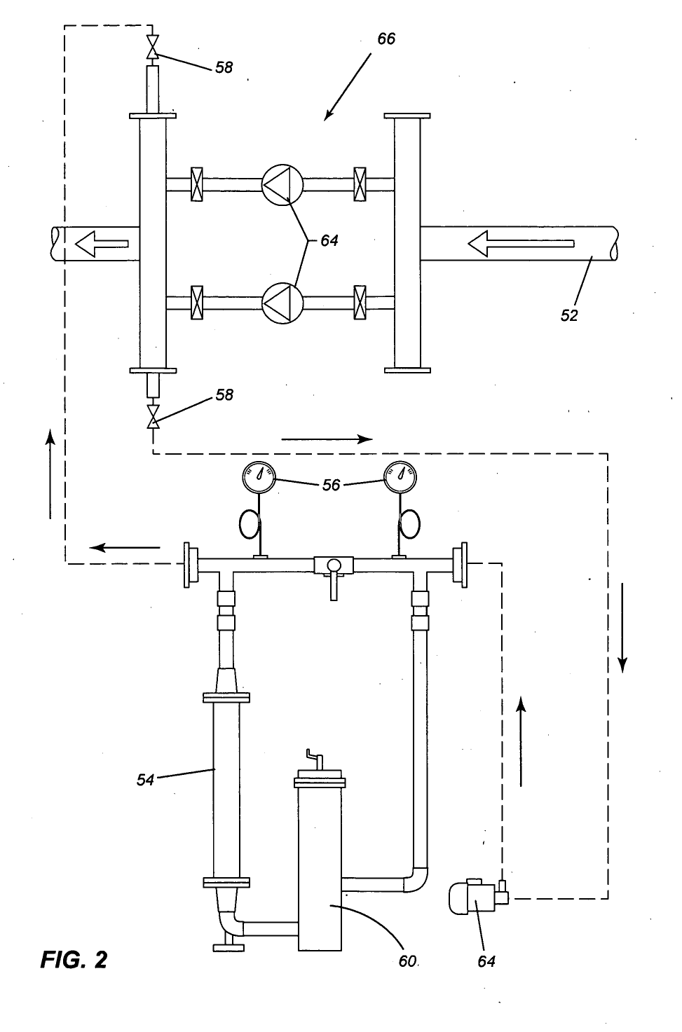

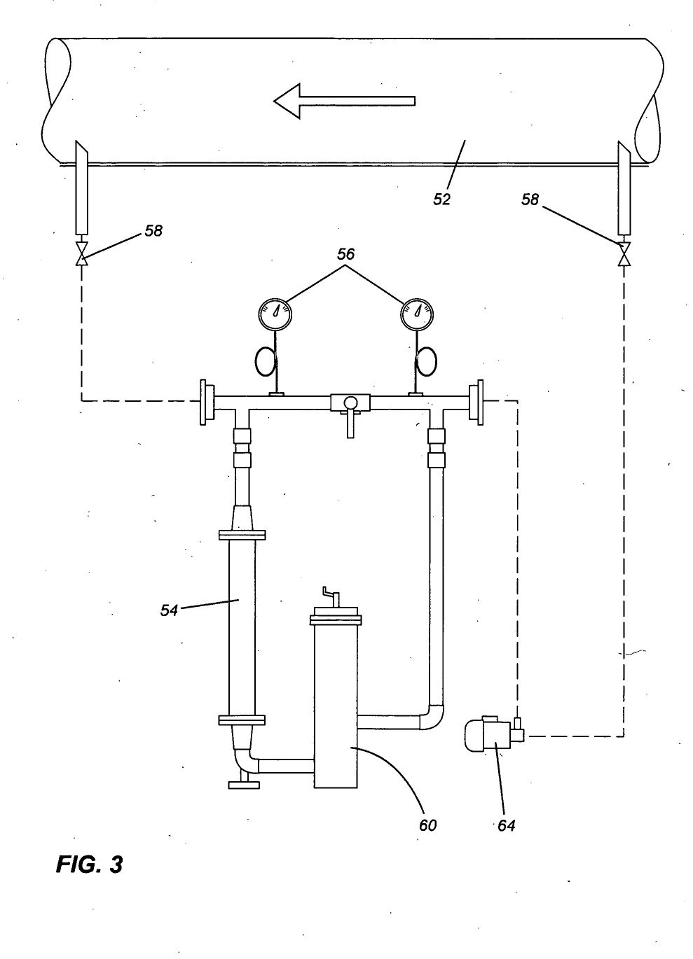

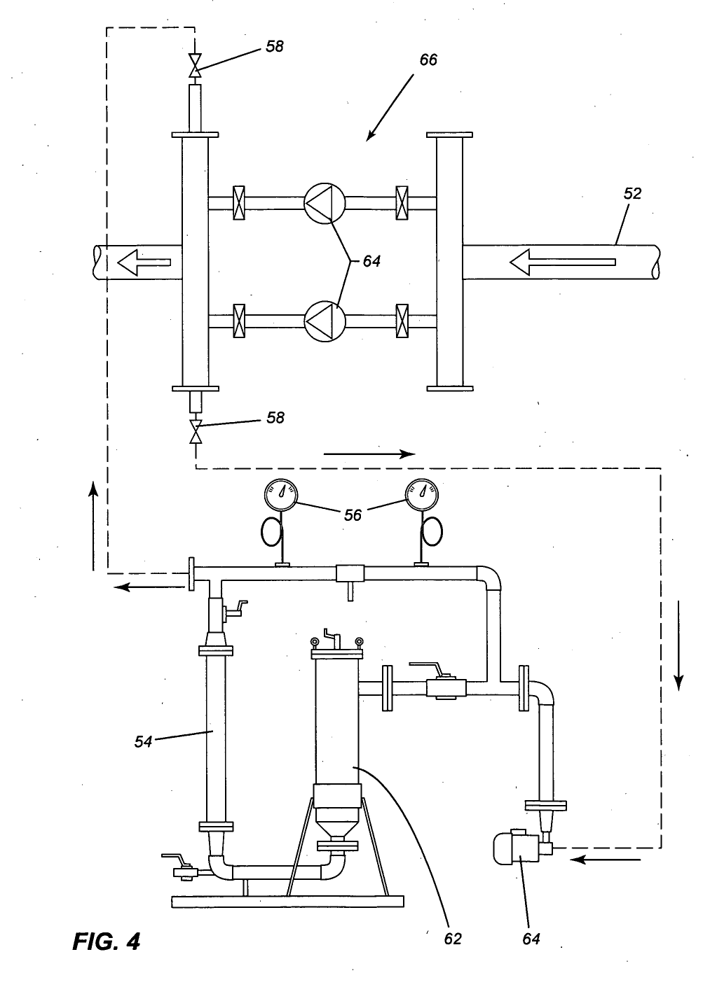

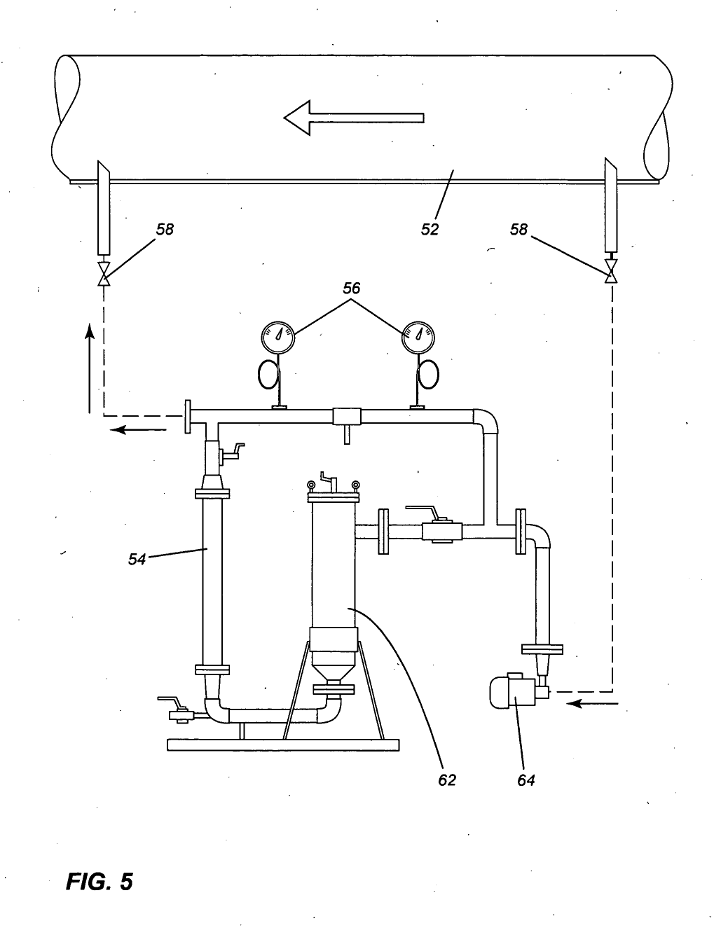

FIGS. 2 to 5 illustrate other arrangements which may be utilized. It is believed that the circuits are self-explanatory with reference numeral 52 designating the pipe through which the liquid is circulated and from where the liquid to be treated is taken. Reference numeral 54 designates the magnetic treatment unit while reference numeral 56 is utilized for gauges. The ball valves are designated by reference numeral 58 while cartridge filters are designated by reference numeral 60. As an alternative to cartridge filters 60, bag filters 62 may be employed. The pumps are designated by reference numeral 64. Reference numeral 66 designates a manifold which may be utilized in cases of limited space.

One large advantage of the system of the present invention is its ability to remove deposits already formed on conduits. In this regard, it is believed that a micro abrasion technique is responsible for removal of the deposits. With treatment according to the system of the present invention, it is believed that the morphology of the solids is changed and they become of a form which, while circulating through the pipes, acts as an abrasive to remove deposits. These deposits are subsequently picked up by the filter.

It will be understood that the above described embodiments are for purposes of illustration only and that changes and modifications may be made thereto without departing from the spirit and scope of the invention

I claim:

1. A method for removing scale from the interior of a conduit in a heat exchanger environment wherein a fluid passes through said conduit, said method comprising the steps of:
diverting a portion of said fluid from said conduit;
passing said diverted portion through a filter;
passing said portion from said filter through a magnetic field in a direction to cut lines of flux such that the direction of water flow and the direction of the flux lines are set at an angle; and
reintroducing said fluid into said conduit at a point downstream of a point where said fluid is diverted.

2. The method of claim 1 wherein said heat exchanger is utilized with a boiler.

3. The method of claim 1 wherein said step of diverting a portion of said fluid from said conduit comprises diverting between 5 and 15% of said fluid.

4. The method of claim 1 wherein the step of diverting a portion of said fluid from said conduit comprises diverting between 8 and 10% of said fluid.

5. The method of claim 4 wherein said heat exchange is utilized with a thermopump.

6. The method of claim 1 wherein said fluid comprises a glycol mix.

7. The method of claim 1 further including the step of measuring the pressure drop across said filter.

8. A method for removing bacteria from a heat transfer system having a chiller and wherein a fluid is circulated through a conduit, the method comprising the steps of:
diverting a portion of said fluid from said conduit;
passing said diverted portion through a filter;
passing said portion from said filter through a magnetic field in a direction to cut lines of flux such that the direction of water flow and the direction of the flux lines are set at an angle; and
reintroducing said fluid into said conduit at a point downstream of a point where said fluid is diverted.

9. The method of claim 8 further including the step of pumping said fluid diverted from said conduit.

10. The method of claim 9 further including the step of measuring the pressure drop across said filter.

11. In a heat exchanger, the improvement comprising a scale reducing apparatus, said scale reducing apparatus comprising a first conduit for removing a portion of a circulating fluid from said heat exchanger, a pump, a filter located downstream of said pump, a magnetic treatment device wherein said portion of said fluid is passed through lines of flux such that the direction of fluid flow and the direction of the flux lines are set at an angle with respect to each other, and a second conduit for returning said treated fluid.
